(19) United States
(12) Patent Application Publication
(10) Pub. No.: US 2012/0036399 A1
(43) Pub. Date: Feb. 9, 2012

(54) System And Method For Automated Software Application Development

(75) Inventor: Kevin D. Howard, Tempe, AZ (US)

(73) Assignee: Massively Parallel Technologies, Inc.

(21) Appl. No.: 12/852,919

(22) Filed: Aug. 9, 2010

(51) Int. Cl. G06F 11/36; G06F 15/16; G06F 9/44; G06F 17/30

(52) U.S. Cl. 714/49; 707/780; 709/206; 717/131; 707/E17.061; 714/E11.208

(57) ABSTRACT

A computer-implemented method for identifying a new software application to be developed. A computer database is searched for matching keywords that correspond to any of a group of selected keywords, indicative of the new application. The database contains descriptive keywords which are indicative of a set of existing applications. If no matching keywords are found in the database, then a description of the new application is requested from the potential user; the description of the new application is received from the potential user; and the description of the new application is used as a basis for developing the new application.

### BACKGROUND

Previous systems offer application software to customers but do not provide a way to directly interact with the application development community. In the standard software application store model, developers have only indirect information regarding customer demand. When errors are found by users of the applications, it is often difficult to provide enough information to the developers to reproduce the problems causing the errors. After a problem has been repaired, customers who have experienced the problem are often not informed that the problem has been addressed.

In standard application store systems, users have to wait for new code releases or software downloads to get access to new application functionality. In addition, standard applications offer limited methods for a user to gain additional processing performance when needed or desired. Standard applications have a fixed processing performance, making processing performance gains a function of either the hardware that runs the application or the specific version of the application.

### SOLUTION

An integrated, automated customer-demand-to-application-development process is presented as a single function, reducing software application development risk and introducing a significant new capability for software application development. Unlike standard application stores (for example, the Apple “App Store” or the Microsoft Store), the present software application development system (“application store”) combines diversity of ideas of a software developer community, the ability for users to directly communicate with that community, and in addition, the shopping convenience of an online store.

For all applications sold through the present application store, customers can directly inform the developers of any problems, submit the input/parameter values that generated the problems, and receive direct notification (both through the application itself and via email) when their problem has been addressed. This process provides application developers the ability to quickly repair and notify only those customers who have an interest in that particular problem's resolution. For each application sold through the present application store, additional application functionality can be requested and provided, allowing customers direct access to customized software applications from the original software developer.

The processing performance of applications developed with the present system can be dynamically changed at the request of the customer, with the increased performance being a function of the amount of computational resources provided by the cloud computing environment. Dynamic, real-time application performance changes represent a new capability for on-line applications.

Allowing customers, developers, and the computing environment the ability to interact as a community makes it possible for developers to create high-quality applications that are desired by customers, and whose performance is dictated by the customer. The interaction that takes place in the present system facilitates the public availability of features needed in a particular application.

### BRIEF DESCRIPTION OF THE DRAWINGS

FIG. 1 is a system diagram showing an exemplary system for automating a customer-demand-to-application-development process;

FIG. 2 is a flowchart showing a set of steps performed in an exemplary embodiment to determine whether a requested application is available;

FIG. 3A is a table including exemplary information used to track current market demand for an application;

FIG. 3B shows an exemplary ‘Application Description’ screen;

FIG. 4 shows an exemplary ‘Application Detail’ screen;

FIG. 5 shows an exemplary ‘Shopping Cart’ screen;

FIG. 6 shows an exemplary ‘Checkout’ screen;

FIG. 7 is a flowchart showing a set of steps performed in an exemplary embodiment to implement a request for a change to an application;

FIG. 8 is a flowchart showing a set of steps performed in an exemplary embodiment to report and repair a ‘bug’ in an application; and

FIG. 9 shows an exemplary ‘Algorithm Trace’ screen; and

FIG. 10 is a flowchart showing a set of steps performed in an exemplary embodiment to compare the performance of two applications.

### DETAILED DESCRIPTION

In response to customer inquiries, the present application store system uses a search engine and keywords to determine if a needed application exists; if it does not, a demand-based development cycle is initiated in which customers provide their software application requirements directly to application developers.

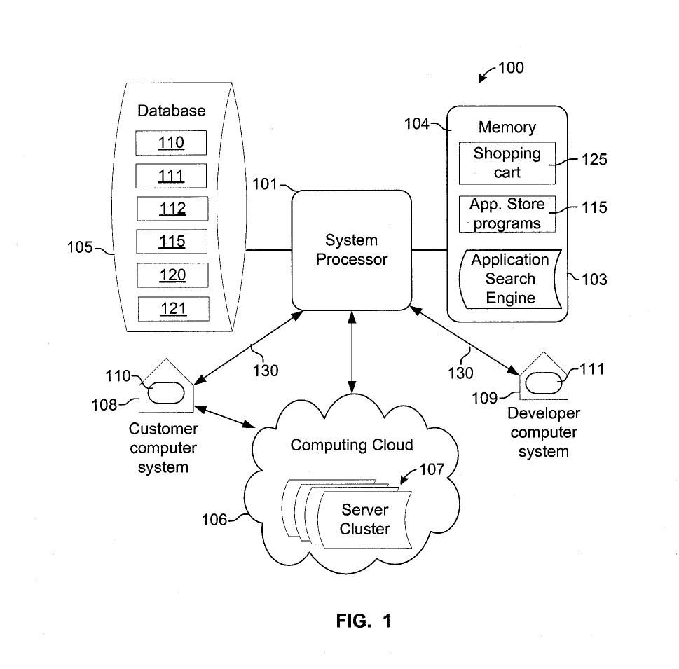

FIG. 1 is a system diagram showing high-level components of an exemplary system 100 for automating a customer-demand-to-application-development process. As shown in FIG. 1, application store system 100 comprises a marketing and development cloud computing system 101. A cloud computing system is a group of servers used to offload the processing and/or large-scale data storage from a user's computer system. Each server in system 101 includes associated memory 104 which includes an application search engine 103, although the search engine may be external to processor 101. Server memory includes programs 115 which perform the system software application development and marketing functions described herein.

Marketing and development cloud computing system 101 is coupled to a database 105 and an ‘application deployment parallel computing cloud’ 106 which includes at least one server cluster 107 which provides parallel processing capability for executing customer applications. A plurality of customers (who are also users of the applications described herein) and a plurality of developers access system 101 and other system components via, e.g., an Internet connection 130, using respective computer systems 108 and 109 (only one of each is shown for clarity). Monitors 110 and 111 provide messages and data entry fields for communication between customers and developers.

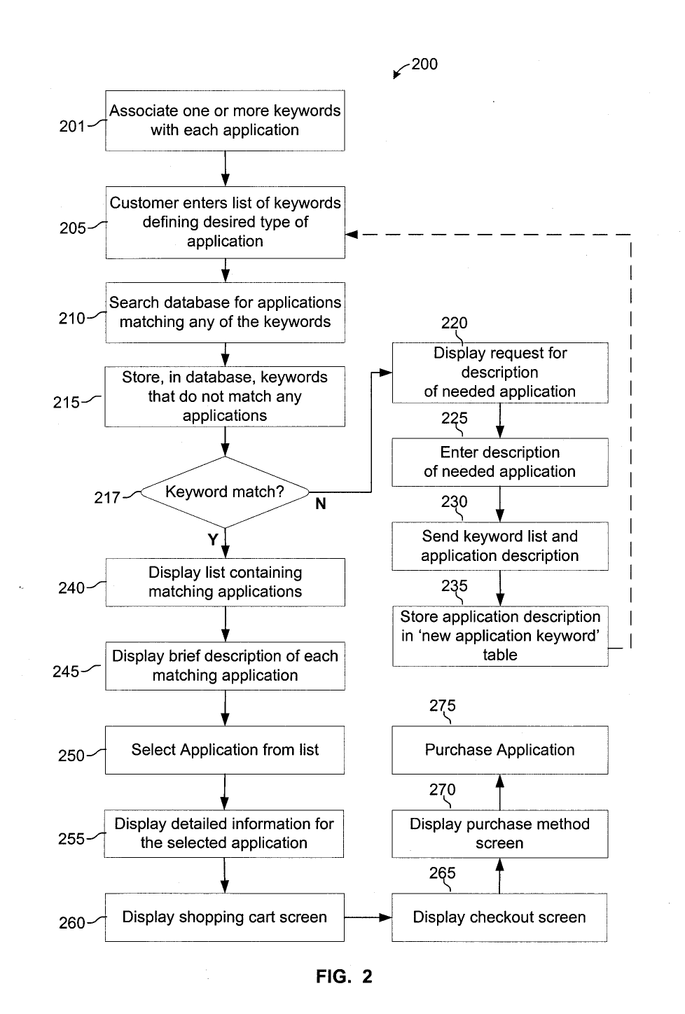

FIG. 2 is a flowchart showing an exemplary set of steps performed in an exemplary embodiment to determine whether a requested application is available. As shown in FIG. 2, at step 201, a list of keywords associated with each application is stored in database file 121 along with the name of the corresponding application. At step 205, a customer enters, via a screen displaying a system ‘main menu’ on the customer's computer system 108, a list of keywords which define, or are associated with, a desired type of application, and then selects a ‘search’ button. The ‘main menu’ screen initially includes a field for entering the list of keywords and a ‘search’ button. At step 210, when the ‘search’ button is selected, application search engine 103 searches ‘existing application keyword’ table 111 in database 105 for applications matching any of the keywords entered by the customer. Search engine 103 may match some of the keywords with existing applications, while other keywords may not have counterpart matching applications in database 105.

At step 215, the system stores (in database 105) the keywords that do not match any existing applications. This information is used to determine new application types. The number of identical or similar keyword requests from different customers defines the potential market size.

The developers participating in the present system have access to this market-demand information and can create applications to meet the demand, and add the keyword(s) to the keyword list for their applications, or, alternatively, the developers may simply ignore the market-demand information.

If the keyword search produces no application matches (step 217) then the system displays a question asking for a short description of the needed application on an application description screen, at step 220. The customer then enters a description of the needed application at step 225, and sends the description and keyword list to system 101 (step 230), from which it can be accessed for use by the development community. The customer's display is then returned to the system main menu. This process allows customers to directly request new applications. The application description entered by the customer is then stored in a ‘new application keyword’ table 112 in database 105, at step 235. The application description is then used by one or more of the developers as a basis for, or at least a significant guideline in, developing a corresponding new application. Table 1 below is an example of the new application keyword table 112.

TABLE 1

| | | | Functional |
|---|---|---|---|
| Keyword # | Keyword | Date | Description |
| 1 | fft | May 18, 2010 | 2-dimensional |
| | | | Fast Fourier |
| | | | Transform |
| — | — | — | — |

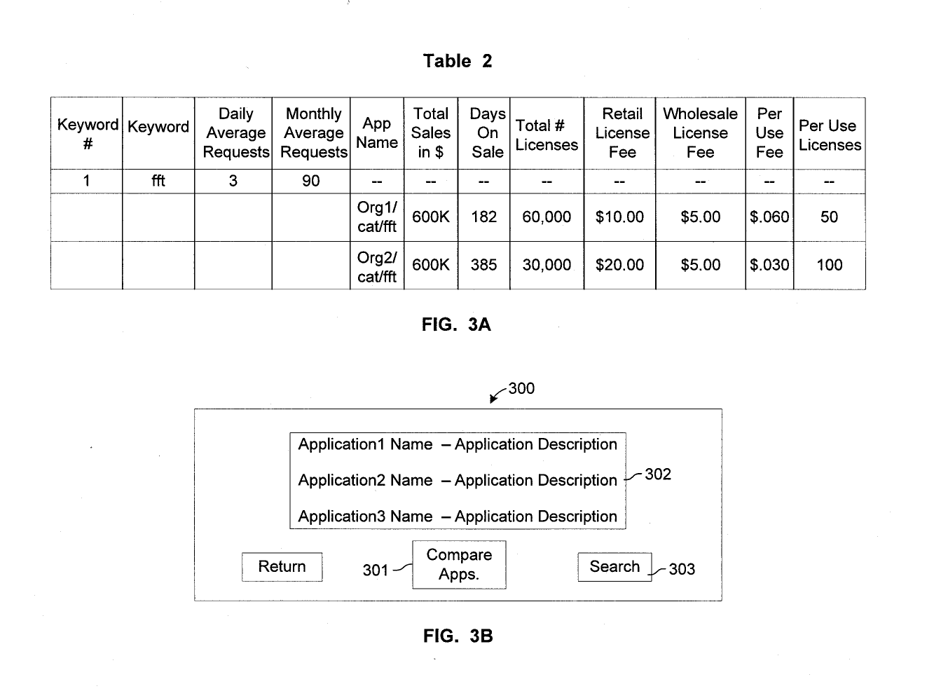

In addition to prompting new market areas, keyword information may be used for tracking current market demand. Table 2 in FIG. 3A shows an exemplary representation of how the current market demand for an application may be tracked. As shown in FIG. 3, information associated with customer-entered keywords may include marketing-related information such as daily and monthly average requests, total sales amounts and number of licenses, retail, wholesale, and per-use license fees, and the number of per-use licenses issued. This information is compiled for each application that matches a particular keyword.

A market tracking table 110, stored in database 105, includes the information shown in Table 2 (FIG. 3A), and may show up-to-the-minute market information. Since, in an exemplary embodiment, every keyword in keyword table 112 has an associated list of products with pricing information, the number of users, and sales figures, it becomes possible to create detailed marketing graphs. This information can be used by the development community to determine which products are in demand, and also to set competitive prices for those products.

If the keyword search (at step 217) finds applications that match one or more keywords in the application description submitted by the customer, then an ‘Application Selection’ list 302, containing a list of matching applications is displayed on an ‘Application Description’ screen 300, at step 240. FIG. 3B shows an exemplary ‘Application Description’ screen 300 which contains an Application Selection list 302 displaying matching applications and short descriptions thereof.

At step 245, the customer may select a an application name in the Application Selection list 302, and a brief application description is shown for each matching application is then displayed. Application information is stored in database file 115, and the information for each application references the corresponding application code stored in database file 120 (shown in FIG. 1). A ‘Next Page’ button may be selected (e.g., by left-clicking on the button), to display the next page of applications, if there is more than one page to be displayed. The order in which the applications are displayed is a function of the ‘popularity’ of those applications, as determined by information stored in market tracking table 110.

At this point, if the customer finds no applications of interest in the Application Selection list, then the customer can either return to the main menu or select an application for which more information is desired. If a return to the main menu is chosen, then system operation resumes at step 205. Otherwise, at step 250, the customer selects an application name in the Application Selection list, and a detailed application description for the selected application is then displayed on an ‘Application Detail’ screen at step 255.

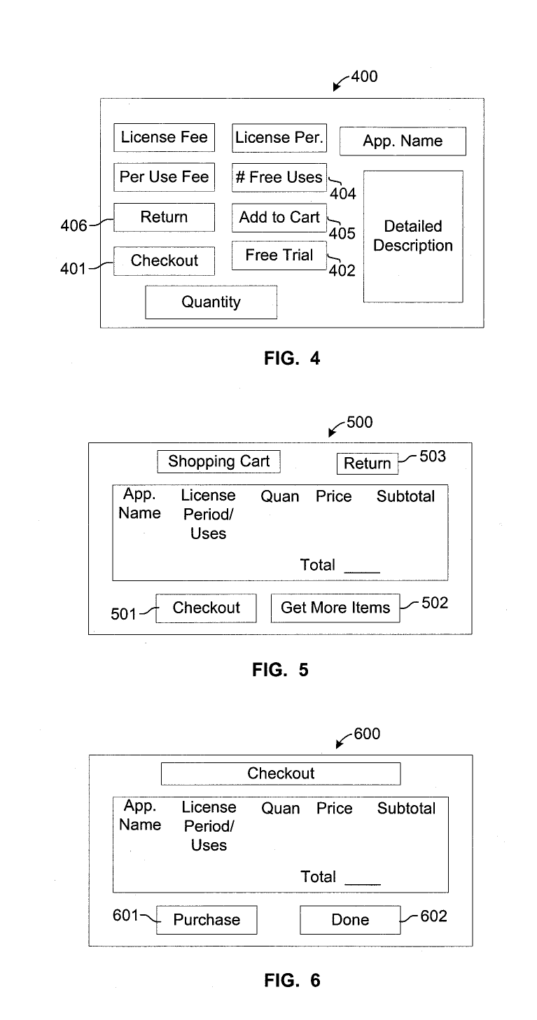

FIG. 4 shows an exemplary Application Detail screen 400. The Checkout button on the Application Detail screen is disabled until an item has been placed in the shopping cart. To place an item into the shopping cart the user Selects the Add to Cart button 405 on the Application Detail screen. If the user wants to try out the application displayed on the Application Detail screen and the number of free uses (field 404) is greater than one then the user selects a Free Trial button 402 which activates the application and decreases the number of free uses by one. The number of free uses is set by the developer, during application development. When execution of the application is complete, control is returned to the Application Detail screen. The user can return to the Application selection list by selecting the Return button 406. Selecting the Return button allows the user to obtain another application.

A detailed description of the current application is shown when the Application Detail Screen is displayed. If the user wishes to purchase the selected application, then selecting the ‘Add to Cart’ button 405 from the Application Detail screen causes the shopping cart screen 500 to be displayed at step 260. Selecting the Checkout button 401 from the Application Detail screen causes a Checkout screen (described below with respect to FIG. 6) to be displayed.

FIG. 5 shows an exemplary Shopping Cart screen 500. Selecting the ‘Checkout’ button 501 on the Shopping Cart screen causes a Checkout screen to be displayed at step 265. Selecting the Return button 503 causes the system to return to the Application Detail screen Selecting the ‘Get More Items’ button 502 causes the system to return to the ‘Application Description’ screen 300 displaying Application Selection List 302.

FIG. 6 shows an exemplary ‘Checkout’ screen. The only significant differences between selecting the Checkout button versus the Free-trial button are the license period and the price for the item displayed on the Checkout screen. If ‘Free Trial’ is selected, then the price is zero and, instead of a license period, there is a specified number of uses. If the ‘Purchase’ button 601 is selected on the Checkout screen, a ‘Purchase Method’ screen is displayed at step 270. If the ‘Done’ button 602 is selected, the main menu is returned to.

The Purchase Method screen comprises one or more buttons which allow a customer to select a purchasing mechanism such as a particular credit card or other payment method. Payment is then made, at step 275, by selecting the appropriate payment method. Once payment is accepted, the system generates another screen with a client code identifying the client. The customer then selects a ‘Done’ button, which returns the customer to the system main menu.

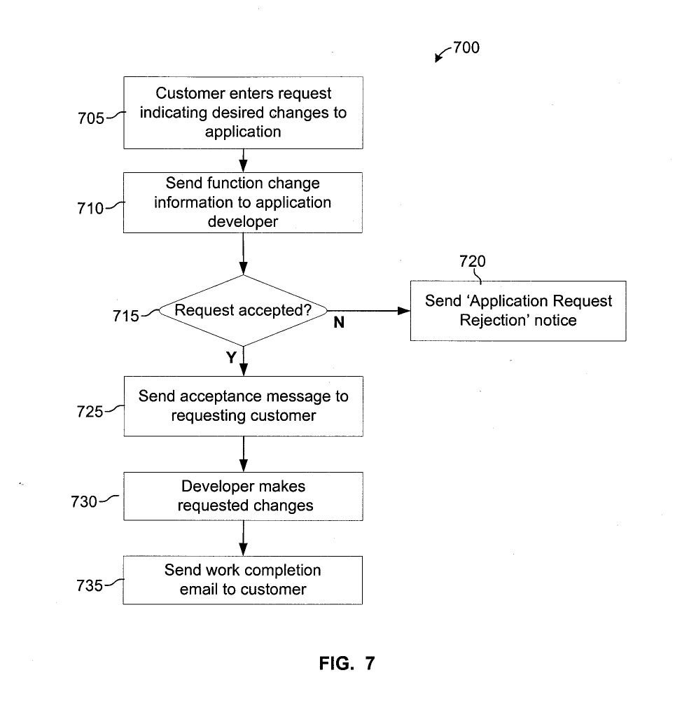

FIG. 7 is a flowchart showing a set of steps performed in an exemplary embodiment to implement a request for a functional or other change to an application. Associated with every application provided by the present system is a ‘Startup’ screen (displayed on monitor 110) that allows the user to interact with the developer community and request changes to application functionality and report errors. The Startup screen is part of the application interface, and is integrated with the application. The Startup screen is coupled to a communication program which provides a mechanism for communication between a system user and the development community via, for example, an Internet connection 130 (shown in FIG. 1).

The Startup screen includes a ‘Request Change’ button that allows the user (the customer) to request additional application functionality though a ‘Functionality Change Request’ screen, which includes a field for entering a request for changing particular aspects of the application. At step 705, once the customer has selected the ‘Request Change’ button and entered the request indicating desired changes to application, the function change information is sent to the developer of the application at step 710.

An ‘Administrator’ main screen (displayed on monitor 111) is available for use by developers using the present system. When an administrative-level user (“administrator”) in the present system selects a ‘Client Request’ button, a ‘Client Function Request List’ screen is then displayed. The administrator can accept or reject each request. If (at step 715) the administrator rejects the request then the system sends an ‘Application Request Rejection’ notice, which includes a reason for the rejection, at step 720. The developers' messages are displayed on Startup screen, and if the customer's email address has been entered, (when the change request was made), then the response will also be sent to the entered email address.

If the administrator accepts the request (i.e., agrees to provide the requested changes) then the system returns an acceptance message to the customer at step 725, and (after appropriate payment by the customer) a developer then makes the requested changes at step 730. After the work is completed and the administrator has issued a client publication, the administrator selects a button which causes the system to send a work completion email to the customer at step 735.

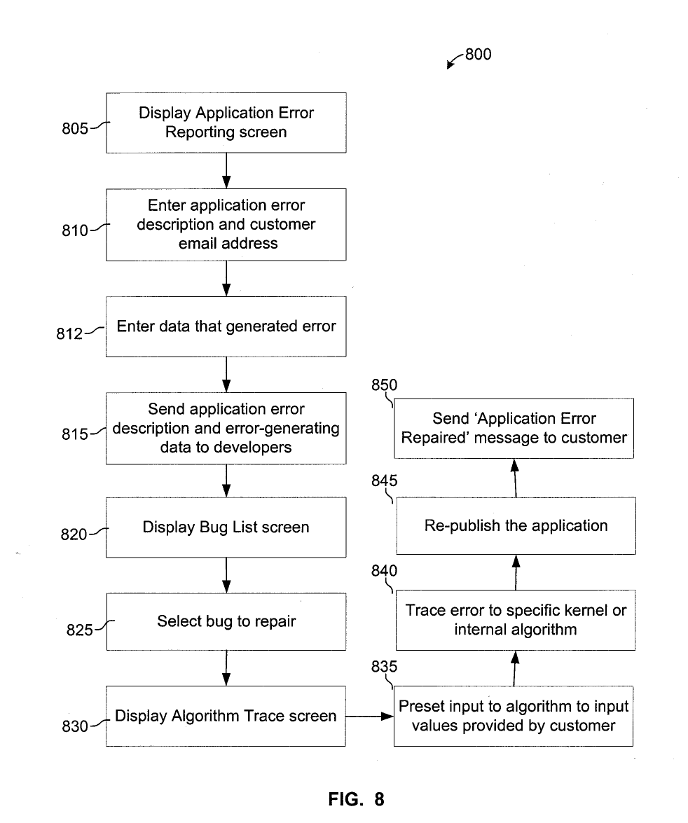

FIG. 8 is a flowchart showing a set of steps performed in an exemplary embodiment to report and repair a ‘bug’ in an application. The Startup screen includes a ‘Bug’ button. Selecting the Bug button at step 805 causes an Application Error Reporting screen to be displayed, into which the customer enters an application error description and an email address at step 810. The customer then selects an ‘Enter Data’ button, and the system displays a ‘Applications data Input’ screen. The customer then enters the input data that generated the error at step 812. The customer then selects a ‘Send’ button which causes the system to send the error description and customer email address to the appropriate developers at step 815.

The developer's Administrator Main screen includes a ‘Bug List’ button. Selecting the Bug List button causes a ‘Bug List’ screen to be displayed at step 820. At step 825, the administrator then selects a specific ‘bug’ from a list of outstanding ‘bugs’ to be fixed, which causes an ‘Algorithm Trace’ screen to be displayed at step 830.

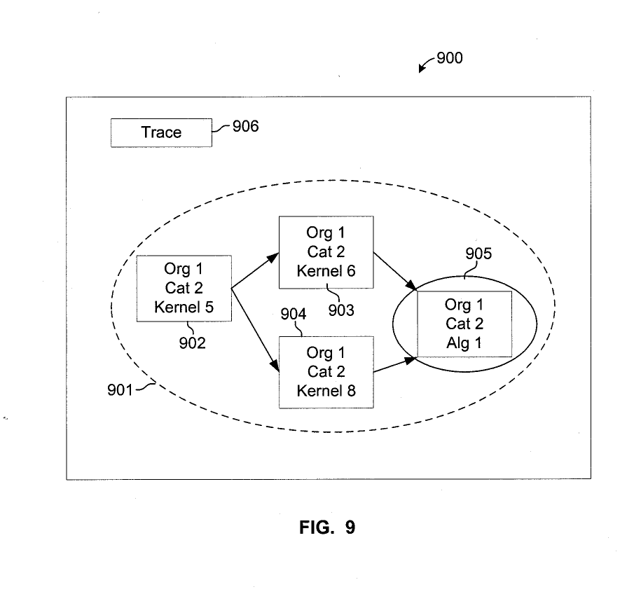

FIG. 9 shows an exemplary Algorithm Trace screen 900. The Algorithm Trace screen displays a block diagram 901 of the algorithm of interest that was published as the application whose code contains the reported ‘bug’. The block diagram 901 of the algorithm includes blocks representing modules, such as kernels (blocks 902, 903, 904) and internal algorithms (block 905), in the algorithm of interest, and shows data flow between the modules via arrows.

At step 835, the input to the algorithm is preset to the input values provided by the customer. The error is then traced by a developer using a ‘Trace’ button 906 to trace the activity and transformations through the kernels (and sub-algorithms) of the application to a specific kernel or internal algorithm at step 840. If the kernel or algorithm causing the problem was created by the present development organization, then the creator of the faulty code is assigned error repair duties by the administrator. When the problem is repaired so that the data from the customer generates a correct response, the administrator re-publishes the application (at step 845), the bug is removed from the Bug list, and an ‘Application Error Repaired’ message is sent to the customer at step 850, indicating that the reported bug has been fixed.

In one embodiment, applications sold via the present method have a performance enhancement bar on the associated Startup screen. After the appropriate parameters are entered into the application, a Performance Enhancement Slider Bar becomes active. The Slider bar initially shows the processing time with a price of $0.00. This processing time can be decreased at a cost. Moving the Slider bar causes the processing time estimate to decrease while also increasing the cost. When the required performance is entered, the customer can select a Run button. If the price on the Slider bar is greater than zero then the system displays the Checkout screen. The user pays for the performance enhancement, and the system runs the job. If the price is zero then the system runs the job without displaying the Checkout screen.

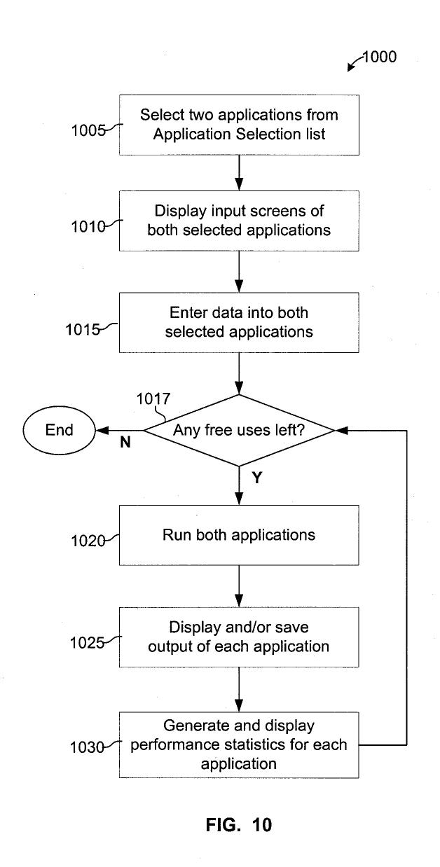

Application software can behave differently depending upon datasets and the input parameters used to define the processing performed on that data. FIG. 10 is a flowchart showing a set of steps 1000 performed in an exemplary embodiment to compare the performance of two applications. When the Application Description screen 300, which contains an Application Selection list 302, is displayed, the customer selects two applications (at step 1005). The input screens of both selected applications then appear as separate popup windows at step 1010. The input data is first entered into one window, then into the other window, followed by selecting a ‘Compare App’ button 301 (shown in FIG. 3B) at step 1015.

Only applications for which there is least one ‘number of free uses’ made available by the developer can be compared. If any ‘free uses’ are available (step 1017), the applications are run at step 1020, and the output of each application is made available in a request data file and/or on an output popup screen at step 1025. Statistics on the performance of each application are generated and displayed at step 1030. These statistics may include, for example, minimum performance (e.g., Mb/sec.), minimum price per use, minimum price-to-performance ratio (e.g., $/Mb/sec.), maximum performance (e.g., Mb/sec.), maximum price per use (e.g., $/Mb/sec.), which includes performance booster cost, and maximum price-to-performance ratio (e.g., $/Mb/sec.). If any ‘free uses’ remain (step 1017), comparisons can continue until there are no further free uses.

The above procedure allows a customer to fairly compare two applications, receive back the computed comparison values, and obtain price-to-performance data for each application using the customer's own dataset. The number of free uses feature allows the developer to limit the total number of free jobs that any particular MAC address consumes, thereby insuring that customers do not abuse the comparison feature.

What is claimed is:

1. A computer-implemented method for identifying a new software application to be developed comprising:
searching a computer database for matching keywords that correspond to any of a group of selected keywords, indicative of the new application, chosen by a potential user of the new application;
wherein the database contains descriptive keywords which are indicative of a set of existing applications; and
when no matching keywords are found in the database, then:
requesting, from the potential user, a description of the new application;
receiving the description of the new application from the potential user; and
using the description of the new application as a basis for developing the new application.

2. A computer-implemented method for determining the relative demand for a plurality of products comprising:
associating a plurality of keywords with each of the plurality of products;
receiving product requests from each of a plurality of users, wherein each of the requests includes at least one said keyword descriptive of one of the products;
generating a table comprising the keywords, wherein each of the keywords has (a) associated information including the number of said requests, by the potential users, in which the keyword was included, and (b) sales amounts for each of the products associated with the keyword.

3. The method of claim 2, wherein each of the keywords has associated information further including the number of licenses issued for each of the products associated with the keyword, and license fees for the products associated with the keyword.

4. The method of claim 2, wherein the table is used to establish pricing for the products.

5. The method of claim 2, wherein the products are software applications.

6. The method of claim 5, including integrating, with each of the applications, a program that requests the keywords and sends them to one or more software developers.

7. A computer-implemented method for enabling a user of a software application to request functional changes to the application comprising:
sending, from a user of the application to a developer thereof, an application change request including information indicating requested changes to the application, wherein the information is sent via a program integrated with the application;
sending, from the developer to the user, a message indicating an agreement to provide the requested changes;
making the requested changes to the application; and
making the application, including the requested changes, available to the user.

8. The method of claim 7, wherein the user is notified, via email, that the requested changes have been made to the application.

9. The method of claim 8, wherein the user is notified of completion of the changes to the application via a program integrated with the application.

10. The method of claim 7, wherein the developer indicates a rejection of the user's change request via a message sent to the user via a program integrated with the application.

11. The method of claim 7, wherein the developer informs the user of a reason the requested application changes were rejected via a program integrated with the application.

12. The method of claim 7, wherein a plurality of developers are sent each said application change request submitted by each said user of each said application.

13. A computer-implemented method for enabling a user of a software application to report errors in the application comprising:
integrating a communication program with the application;
using the communication program to send, from a user of the application to a developer thereof, an error report including information indicative of one or more said errors in the application.

14. The method of claim 13, wherein input data that generated the one or more errors is sent with the error report.

15. The method of claim 14, wherein the developer uses the input parameter data to reproduce reported error conditions.

16. A computer-implemented method for comparing performance of two applications comprising:
selecting two applications from a list of applications;
entering data into the two applications;
simultaneously executing the two applications;
displaying and saving the output of the two applications; and
generating and displaying performance statistics for each of the two applications.

17. The method of claim 16, wherein the performance statistics include minimum performance, minimum price per use, minimum price-to-performance ratio, maximum performance, and maximum price-to-performance ratio.

18. The method of claim 16, further including:
determining whether there are any free uses remaining for each of the selected applications; and
if there are no free uses remaining for either of the selected applications, then inhibiting comparison thereof.
